(19) United States
(12) Patent Application Publication
(10) Pub. No.: US 2021/0083312 A1
(43) Pub. Date: Mar. 18, 2021

(54) FUEL CELL STACK, TERMINAL STRUCTURE FOR FUEL CELL STACK, AND METHOD OF PRODUCING TERMINAL STRUCTURE FOR FUEL CELL STACK

(71) Applicant: HONDA MOTOR CO., LTD., Tokyo (JP)

(72) Inventor: Yuta IKEDA, WAKO-SHI (JP)

(21) Appl. No.: 17/017,063

(22) Filed: Sep. 10, 2020

(30) Foreign Application Priority Data
Sep. 13, 2019 (JP) 2019-167056

(51) Int. Cl. H01M 8/2465; H01M 8/0258

(52) U.S. Cl. CPC H01M 8/2465; H01M 8/0258

(57) ABSTRACT

In terminal structure, one surface of a current collection plate is positioned adjacent to a stack body of power generation cells. A plate joint surface of an intermediate plate is joined to the other surface of the current collection plate. A rod terminal is joined to a terminal joint surface of the intermediate plate. A terminal joint portion for joining the intermediate plate and the rod terminal together is provided at the center of the intermediate plate as viewed in the stacking direction. A plate joint portion for joining the current collection plate and the intermediate plate together is provided on the outer circumferential side of the intermediate plate as viewed in the stacking direction.

### CROSS-REFERENCE TO RELATED APPLICATION

This application is based upon and claims the benefit of priority from Japanese Patent Application No. 2019-167056 filed on Sep. 13, 2019, the contents of which are incorporated herein by reference.

### BACKGROUND OF THE INVENTION

### Field of the Invention

The present invention relates to a fuel cell stack including a stack body formed by stacking a plurality of power generation cells together in a stacking direction, and terminal structures provided at both ends of the stack body formed in the stacking direction. Further, the present invention relates to the terminal structure for the fuel cell stack, and a method of producing the terminal structure for the fuel cell stack.

### Description of the Related Art

For example, a solid polymer electrolyte fuel cell includes a membrane electrode assembly (MEA). The membrane electrode assembly includes an electrolyte membrane, an anode provided on one surface of the electrolyte membrane, and a cathode provided on the other surface of the electrolyte membrane. The membrane electrode assembly is sandwiched between separators to form a power generation cell. A plurality of the power generation cells are stacked together to form a stack body.

Terminal structures, an insulating plate, and an end plate are stacked on each of both ends of the stack body in the stacking direction in this order to form a fuel cell stack. The terminal structures are electrically connected to the stack body, and enable the power generation electrical energy of the stack body to be collected to the outside. The insulating plate is provided between the terminal structure and the end plate to electrically insulate the terminal structure and the end plate from each other. The end plates maintain the state of the plurality of power generation cells, etc. that are stacked together, and hold the stack body through the insulating plate and the terminal structure to apply the tightening load, in a manner that suitable magnitude of surface pressure is applied to the power generation cells.

As the terminal structure of this type, for example, as shown in Japanese Patent No. 5214281, terminal structure having an electrically conductive current collection plate stacked on a stack body, and a rod terminal for power collection is known. One surface of the current collection plate is a stack surface stacked on the stack body. The other surface of the current collection plate is a terminal joint surface to which the rod terminal is welded. The terminal joint surface of the current collection plate and one end surface of the rod terminal in the axial direction are welded together. In this manner, the current collection plate and the rod terminal are joined together integrally.

Normally, the length of the rod terminal in the axial direction is significantly larger than the thickness of the current collection plate. Therefore, in the state where one end surface of the rod terminal is stacked on the terminal joint surface of the current collection plate, in general, welding is performed in a manner to form the welding bead (welding trace) from the stack surface of the current collection plate. In this case, a recess is formed in the current collection plate by depression from the stack surface toward the terminal joint surface beforehand, and a terminal joint portion between the current collection plate and the rod terminal is provided inside the recess.

As described above, in the case of providing the terminal joint portion inside the recess, by welding from the stack surface of the current collection plate, even if projections such as burrs are produced on the stack surface, it is possible to eliminate and/or reduce the situation where the projections protrude beyond the stack surface of the current collection plate toward the stack body. That is, by making it easier to prevent the projections of the current collection plate from locally contacting the stack body, it is possible to maintain the suitable contact state between the current collection plate and the stack body.

### SUMMARY OF THE INVENTION

As described above, in the terminal structure having the recess in the stack surface of the current collection plate which is positioned adjacent to the stack case, since the inside of the recess of the current collection plate does not contact the stack body, the contact area between the current collection plate and the stack body is reduced. In this case, there are concerns that it becomes difficult to sufficiently apply the tightening load from the end plate to the non-contact portion of the stack body which does not contact the current collection plate, and it becomes difficult to maintain the desired current collection efficiency by the terminal structure due to the increase in the contact resistance between the current collection plate and the stack body.

The present invention has been made taking such problems into account, and an object of the present invention is to provide a fuel cell stack, a terminal structure for the fuel cell stack, and a method of producing the terminal structure for the fuel cell stack in which it is possible to suitably ensure that the contact area between a stack body and a current collection plate is sufficient.

According to an aspect of the present invention, a fuel cell stack is provided, the fuel cell stack including a stack body including a plurality of power generation cells stacked together in a stacking direction and terminal structures provided at both ends of the stack body in the stacking direction, wherein each of the terminal structures includes an electrically conductive current collection plate having one surface and another surface, the one surface of the current collection plate being positioned adjacent to the stack body, an electrically conductive intermediate plate including a plate joint surface and a terminal joint surface as a back surface of the plate joint surface, the plate joint surface being joined to the other surface of the current collection plate, and an electrically conductive rod terminal joined to the terminal joint surface of the intermediate plate, and protruding from the intermediate plate toward a side opposite to the stack body, wherein a terminal joint portion configured to join the intermediate plate and the rod terminal together is provided at a central side of the intermediate plate as viewed in the stacking direction, and a plate joint portion configured to join the current collection plate and the intermediate plate together is provided on an outer circumferential side of the intermediate plate as viewed in the stacking direction.

According to another aspect of the present invention, a terminal structure for a fuel cell stack is provided, the fuel cell stack including a stack body including a plurality of power generation cells stacked together in a stacking direction, the terminal structures provided at both ends of the stack body in the stacking direction, wherein each of the terminal structures includes an electrically conductive current collection plate having one surface and another surface, the one surface of the current collection plate being positioned adjacent to the stack body, an electrically conductive intermediate plate including a plate joint surface and a terminal joint surface as a back surface of the plate joint surface, the plate joint surface being joined to the other surface of the current collection plate, and an electrically conductive rod terminal joined to the terminal joint surface of the intermediate plate, and protruding from the intermediate plate toward a side opposite to the stack body, wherein a terminal joint portion configured to join the intermediate plate and the rod terminal together is provided at a central side of the intermediate plate as viewed in the stacking direction, and a plate joint portion configured to join the current collection plate and the intermediate plate together is provided on an outer circumferential side of the intermediate plate as viewed in the stacking direction.

According to still another aspect of the present invention, a method of producing a terminal structure for a fuel cell stack is provided, the fuel cell stack including a stack body including a plurality of power generation cells stacked together in a stacking direction, and the terminal structures provided at both ends of the stack body in the stacking direction, wherein each of the terminal structures includes an electrically conductive current collection plate having one surface and another surface, an electrically conductive intermediate plate including a plate joint surface and a terminal joint surface as a back surface of the plate joint surface, and an electrically conductive rod terminal, the method including the steps of, in a state where one end surface of the rod terminal in an axial direction is brought into contact with a central side of the terminal joint surface of the intermediate plate, joining the intermediate plate and the rod terminal together at a central side of the intermediate plate as viewed in the axial direction by welding from the plate joint surface, to provide a terminal joint portion, and in a state where the plate joint surface of the intermediate plate after the terminal joining step is brought into contact with the other surface of the current collecting plate before the one surface of the current collection plate is positioned adjacent to the stack body, joining the current collection plate and the intermediate plate together on an outer circumferential side of the intermediate plate as viewed in the axial direction by welding from the terminal joint surface, to provide a plate joint portion.

In the terminal structure, the rod terminal is joined to the terminal joint surface of the intermediate plate, and the current collection plate is joined to the plate joint surface of the intermediate plate. In this case, the terminal joint portion for joining the intermediate plate and the rod terminal together can be positioned adjacent to the surface (the other surface) of the current collection plate opposite to the stack body. Further, the plate joint portion for joining the intermediate plate and the current collection plate together can be formed by joining from the terminal joint surface of the intermediate plate. In this manner, it is possible to easily flatten one surface of the current collection plate, of at least the plate joint portion.

That is, by joining the current collection plate and the rod terminal together through the intermediate plate, it is possible to prevent formation of the welding bead (welding trace) from the surface (one surface) of the current collection plate adjacent to the stack body. Therefore, it is possible to avoid formation of projections such as burrs provided as a result of welding in the one surface of the current collection plate. As a result, it is possible to stack the one surface of the flat current collection plate on the stack body without providing recesses, etc. for avoiding contact between the projections and the stack body.

As a result, in the terminal structure, it is possible to suitably ensure that the contact area between the stack body and the current collection plate is sufficient. Moreover, for example, it becomes possible to apply the tightening load from the end plate to the entire stack body through the terminal structure, and efficiently collect the power generation electrical energy of the stack body to the outside by the terminal structure.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a cross sectional view showing main components of a fuel cell stack according to an embodiment of the present invention;

FIG. 2 is an exploded perspective view showing a power generation cell;

FIG. 3 is a perspective view schematically showing terminal structure of a fuel cell stack according to an embodiment of the present invention;

FIG. 4 is a cross sectional view showing terminal structure in FIG. 3;

FIG. 5 is a view showing a terminal joining step of a method of producing the terminal structure in FIG. 3;

FIG. 6A is a cross sectional view schematically showing an intermediate joint body obtained in the terminal joining step in FIG. 5;

FIG. 6B is a view showing a shape of a welding bead as viewed in an axial direction;

FIGS. 6C is a view showing the shape of a welding bead as viewed in the axial direction according to a modified embodiment;

FIGS. 6D is a view showing the shape of a welding bead as viewed in the axial direction according to a modified embodiment;

FIG. 7 is a view showing a plate joining step after the terminal joining step in FIG. 5; and

FIG. 8 is a perspective view schematically showing terminal structure of a fuel cell stack according to a modified embodiment.

### DESCRIPTION OF THE PREFERRED EMBODIMENTS

Preferred embodiments of a fuel cell stack, a terminal structure of the fuel cell stack, and a method of producing the terminal structure for the fuel cell stack according to the present invention will be described in details with reference to the accompanying drawings. In the drawings mentioned below, the constituent elements which have the same or similar functions and which offer the same or similar advantages are labeled with the same reference numerals, and description of such constituent elements may not be repeated.

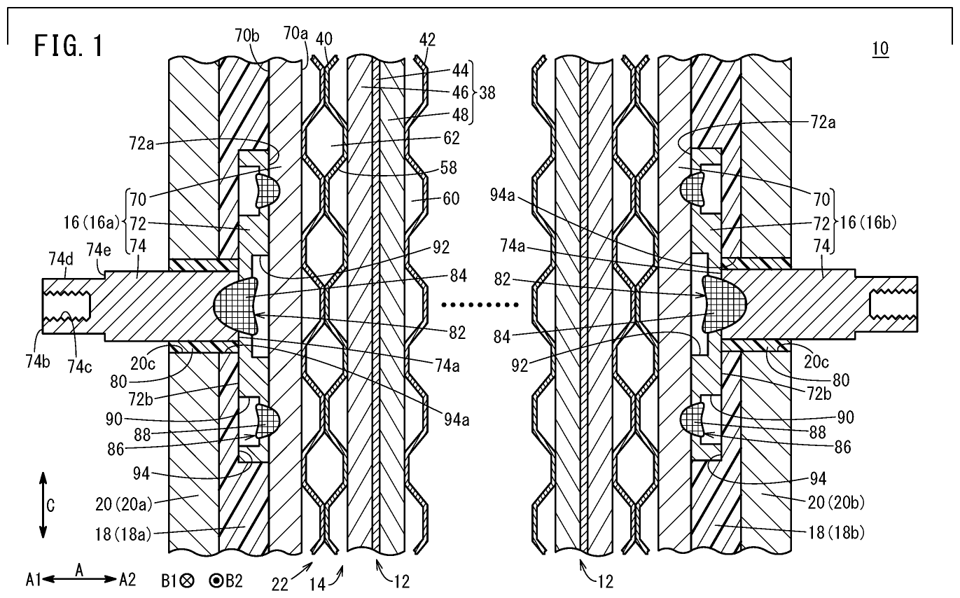

As shown in FIG. 1, for example, a fuel cell stack 10 according to an embodiment of the present invention is mounted in a fuel cell electric automobile (not shown), or used in stationary application, and includes a stack body 14 formed by stacking a plurality of power generation cells 12 in a direction indicated by an arrow A. Further, a terminal structure 16 (hereinafter also simply referred to as the terminal structure 16) for the fuel cell stack 10 according to the embodiment of the present invention is provided at each of both ends of the stack body 14 of the fuel cell stack 10 in the stacking direction (end in the direction indicated by an arrow A1 and end in the direction indicated by an arrow A2).

The terminal structure 16 provided at one end of the stack body 14 in the stacking direction (side indicated by an arrow A1) is also referred to as a first terminal structure 16a. Further, the terminal structure 16 provided at the other end of the stack body 14 (side indicated by an arrow A2) is also referred to as a second terminal structure 16b. The first terminal structure 16a and the second terminal structure 16b are the same structure except that constituent elements of each of the first terminal structure 16a and the second terminal structure 16b are disposed symmetrically on both sides of the stack body 14. For example, in the case where the first terminal structure 16a and the second terminal structure 16b are not distinguished from each other, the first terminal structure 16a and the second terminal structure 16b are simply referred to as the terminal structure(s) 16 collectively.

In the fuel cell stack 10, a first insulating plate 18a is provided outside the first terminal structure 16a in the stacking direction (side indicated by the arrow A1), and a first end plate 20a is provided outside the first insulating plate 18a. A second insulating plate 18b is provided outside the second terminal structure 16b in the stacking direction (side indicated by the arrow A2), and a second end plate 20b is provided outside the second insulating plate 18b.

Hereinafter, the first insulating plate 18a and the second insulating plate 18b are also referred to as the insulating plate 18, collectively, and the first end plate 20a and the second end plate 20b are also referred to as an end plate 20 (end plates 20), collectively.

By providing the terminal structure 16 as described above for the stack body 14, it becomes possible to collect the power generation electrical energy of the stack body 14 to the outside. Further, since the insulating plate 18 is interposed between the terminal structure 16 and the end plate 20, it becomes possible to electrically insulate the terminal structure 16 and the end plate 20.

The stack body 14, the terminal structure 16 and the insulating plate 18 are stacked together as described above to form an inner body 22. Though not shown, for example, the inner body 22 is accommodated in a case, and held between a pair of the end plates 20 from both ends in the stacking direction through an opening, etc. provided in the case. In the structure, the tightening load from the end plate 20 is applied to the stack body 14 through the insulating plate 18 and the terminal structure 16. It should be noted that a tightening load may be applied to the inner body 22 by interposing the inner body 22 between the pair of end plates 20 fixed using tie rods (not shown) in the state where the inner body 22 is not accommodated in the case.

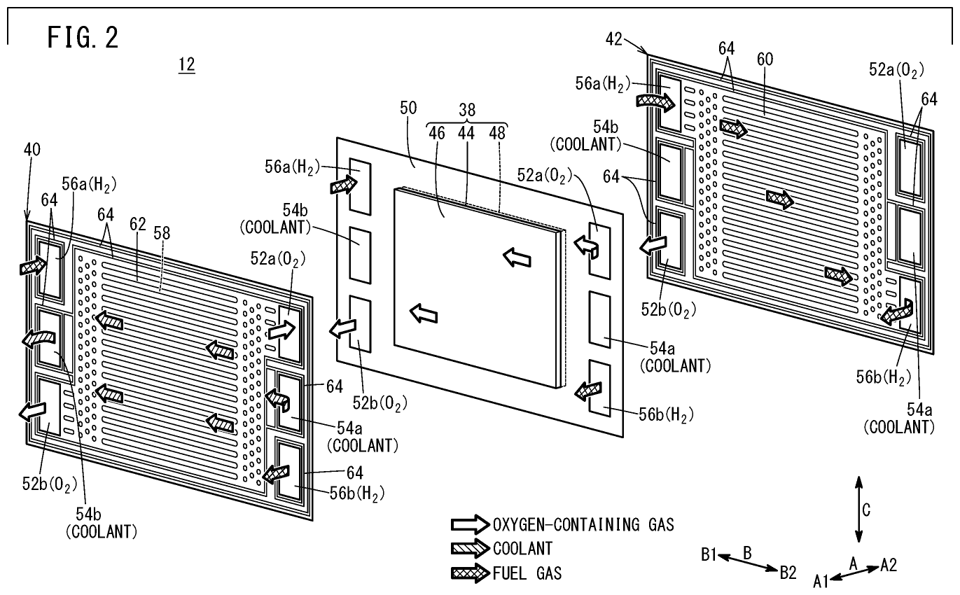

As shown in FIG. 2, each of the power generation cells 12 includes a membrane electrode assembly 38, and a first separator 40 and a second separator 42 sandwiching the membrane electrode assembly 38 from both sides. The membrane electrode assembly 38 includes an electrolyte membrane 44 and a cathode 46 and an anode 48 sandwiching the electrolyte membrane 44. A film shaped resin frame member 50 is provided over the entire periphery of the outer circumferential portion of the membrane electrode assembly 38. The first separator 40 and the second separator 42 are metal separators or carbon separators.

At one end of a rectangular power generation cell 12 in a longitudinal direction (end indicated by an arrow B2), an oxygen-containing gas supply passage 52a, a coolant supply passage 54a, and a fuel gas discharge passage 56b are arranged in a vertical direction (indicated by an arrow C). The oxygen-containing gas supply passage 52a, the coolant supply passage 54a, and the fuel gas discharge passage 56b extend through the power generation cells 12 in the stacking direction (indicated by the arrow A). An oxygen-containing gas is supplied to the oxygen-containing gas supply passage 52a. A coolant is supplied to the coolant supply passage 54a. A fuel gas such as a hydrogen-containing gas is discharged from the fuel gas discharge passage 56b.

At the other end of the power generation cell 12 in a longitudinal direction (end indicated by an arrow B1), a fuel gas supply passage 56a for supplying the fuel gas, a coolant discharge passage 54b for discharging the coolant, and an oxygen-containing gas discharge passage 52b for discharging the oxygen-containing gas are arranged in the vertical direction (indicated by an arrow C). The fuel gas supply passage 56a, the coolant discharge passage 54b, and the oxygen-containing gas discharge passage 52b extend through the power generation cell 12 in the stacking direction.

The first separator 40 has an oxygen-containing gas flow field 58 (FIG. 1) on its surface facing the membrane electrode assembly 38. The oxygen-containing gas flow field 58 is connected to the oxygen-containing gas supply passage 52a and the oxygen-containing gas discharge passage 52b (FIG. 1). The second separator 42 has a fuel gas flow field 60 on its surface facing the membrane electrode assembly 38. The fuel gas flow field 60 is connected to the fuel gas supply passage 56a and the fuel gas discharge passage 56b.

A coolant flow field 62 is provided between the first separator 40 and the second separator 42 of the power generation cells 12 that are adjacent to each other. The coolant flow field 62 is connected to the coolant supply passage 54a and the coolant discharge passage 54b. An elastic seal member 64 is formed integrally with, or formed separately from each of the first separator 40 and the second separator 42. Instead of the seal member 64, a bead seal (not shown) may be provided on each of the first separator 40 and the second separator 42 by press forming.

As shown in FIG. 1, the terminal structure 16 includes an electrically conductive current collection plate 70, an electrically conductive intermediate plate 72, and an electrically conductive rod terminal 74. The following description will be given in connection with an example where the current collection plate 70, the intermediate plate 72, and the rod terminal 74 are arranged in the direction indicated by the arrow A1 in this order to form the first terminal structure 16a.

As shown in FIGS. 1, 3, and 4, the current collection plate 70 is made of electrically conductive material such as copper, aluminum, stainless steel, titanium, or metal chiefly containing these materials, and has a quadrangular shape. As shown in FIG. 1, one surface 70a (surface on the side indicated by the arrow A2) of the current collection plate 70 faces the stack body 14. Another surface 70b (surface on the side indicated by the arrow A1) of the current collection plate 70 is joined to a plate joint surface 72a of the intermediate plate 72 (surface on the side indicated by the arrow A2).

For example, the intermediate plate 72 is made of electrically conductive material such as the above metal listed as the materials of the current collection plate 70. Further, in the embodiment of the present invention, the intermediate plate 72 has a circular shape as viewed in the direction indicated by the arrow A which is smaller than the outer shape of the current collection plate 70. However, the shape of the intermediate plate 72 viewed in the direction indicated by the arrow A is not limited to the circular shape. For example, the intermediate plate 72 viewed in the direction indicated by the arrow A may have a polygonal shape.

The intermediate plate 72 has a terminal joint surface 72b (surface on the side indicated by the arrow A1 as a back surface of the plate joint surface 72a, and one end surface 74a (end surface on the side indicated by the arrow A2) of the rod terminal 74 in the axial direction is joined to the terminal joint surface 72b. Therefore, the rod terminal 74 protrudes toward the side opposite to the stack body 14 from the terminal joint surface 72b of the intermediate plate 72 (the side indicated by the arrow A1).

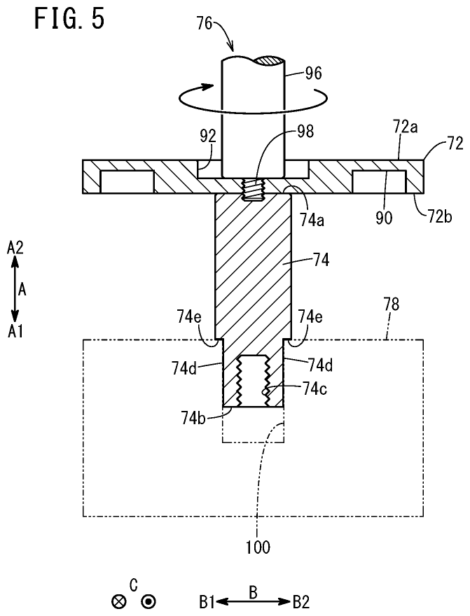

A screw hole 74c for fixing a bus bar (not shown) and power terminal, etc. is formed on another end surface 74b of the rod terminal 74. Further, flat surfaces 74d are provided at two positions in the circumferential surface on the other end surface 74b of the rod terminal 74 in the axial direction. A step surface 74e is formed between the flat surfaces 74d of the rod terminal 74 and the other portion adjacent to the flat surfaces 74d on the side indicated by the arrow A2. As shown in FIG. 5, as described later, at the time of welding the intermediate plate 72 and the rod terminal 74 together, a jig 78 of a friction stir joining apparatus 76 is attached to the flat surfaces 74d of the rod terminal 74 (on the side indicated by the arrow Al). As shown in FIG. 1, the rod terminal 74 is inserted into a through hole 20c penetrating through the end plate 20 in the thickness direction indicated by the arrow A through an insulating sleeve 80.

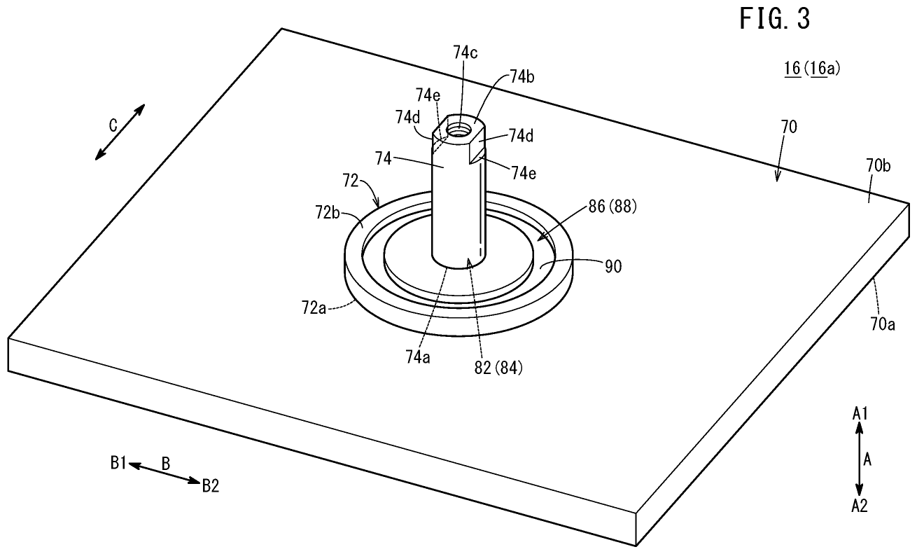

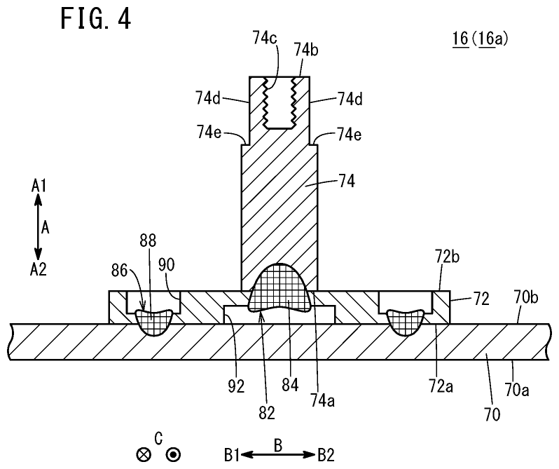

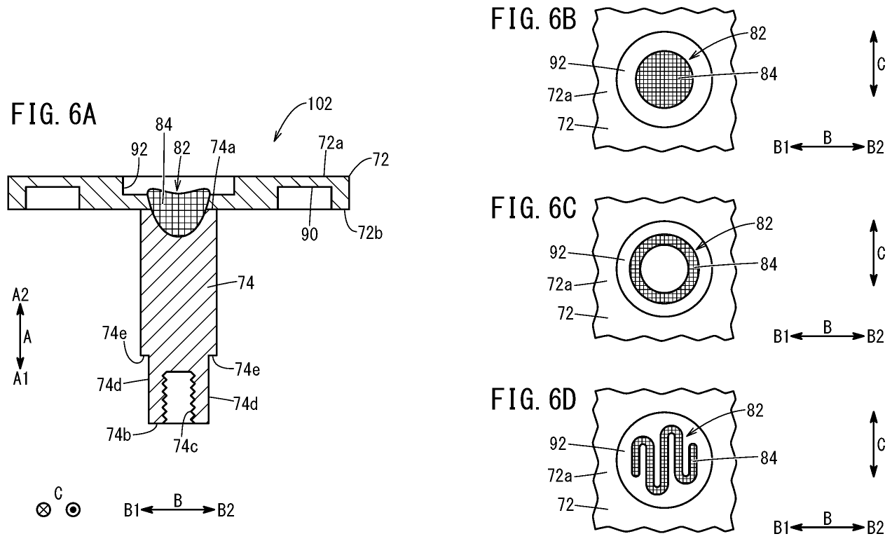

As shown in FIG. 3, a terminal joint portion 82 joining the intermediate plate 72 and the rod terminal 74 is provided at the center of the intermediate plate 72 as viewed in the stacking direction (viewed in the direction indicated by the arrow A). Further, as shown in FIGS. 1 and 4, the terminal joint portion 82 is formed by welding from the plate joint surface 72a of the intermediate plate 72. Therefore, a welding bead (welding trace) 84 is formed in the terminal joint portion 82 from the plate joint surface 72a of the intermediate plate 72. In the embodiment of the present invention, the shape of the welding bead 84 as viewed in the axial direction (indicated by the arrow A) of the rod terminal 74 has a spot shape (circular shape) as shown in FIG. 6B. However, the present invention is not limited in this respect. For example, the welding bead 84 viewed in the axial direction may have a circular annular shape in FIG. 6C, a serpentine shape in FIG. 6D, or a rectangular annular shape (not shown), etc.

As shown in FIG. 3, a plate joint portion 86 for joining the current collection plate 70 and the intermediate plate 72 is provided on the outer circumferential side of the intermediate plate 72 as viewed in the stacking direction. In the embodiment of the present invention, the plate joint portion 86 has an annular shape provided around the outer circumferential portion of the intermediate plate 72. Further, as shown in FIGS. 1 and 4, the plate joint portion 86 is formed by welding from the terminal joint surface 72b of the intermediate plate 72. Therefore, a welding bead 88 is formed in the plate joint portion 86, from the terminal joint surface 72b of the intermediate plate 72. Further, one surface 70a of the current collection plate 70, in at least the plate joint portion 86 is flat.

In the embodiment of the present invention, the shape of the welding bead 88 as viewed in the axial direction (indicated by the arrow A) is an annular shape along the annular plate joint portion 86. However, the welding bead 88 may be provided at one or a plurality of positions on the outer circumferential side of the intermediate plate 72, to extend straight or in a curved line, or in a spot pattern.

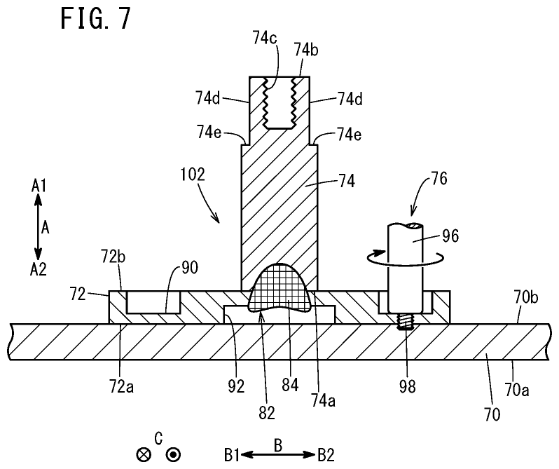

In the embodiment of the present invention, each of the terminal joint portion 82 and the plate joint portion 86 is formed by friction stir joining (FSW: Friction Stir Welding). The friction stir joining is a joining method by plastic flow, without melting welding material, utilizing friction heat generated at the time of embedding a probe 98 (FIGS. 5 and 7) provided at the front of a rotation tool 96 (FIGS. 5 and 7) in the welding material.

The present invention is not limited to friction stir joining. The terminal joint portion 82 may be formed using any of welding methods (e.g., laser welding, MIG welding, TIG welding, etc.) where the welding bead 84 is formed from the plate joint surface 72a of the intermediate plate 72. Further, the plate joint portion 86 is formed using various welding methods (e.g., laser welding, MIG welding, TIG welding, etc.) in which the welding bead 88 is formed from the terminal joint surface 72b of the intermediate plate 72.

The welding method herein means a method of applying one of, or both of heat and pressure, and, if necessary, adding suitable filler material to join the welding material for achieving continuity in the joint portion of the welding material. For example, using any of welding methods such as melt welding by heating weld material, etc. to melt the weld material, and thereafter, solidifying the weld material, and/or pressure joining using the mechanical pressure, it is possible to weld the current collection plate 70 and the intermediate plate 72 together, and weld the intermediate plate 72 and the rod terminal 74 together.

As shown in FIG. 4, a terminal recess 92 is formed in the intermediate plate 72 by depression from the plate joint surface 72a (on the side indicated by the arrow A2) toward the terminal joint surface 72b (on the side indicated by the arrow A1), and the terminal joint portion 82 is formed in the terminal recess 92. Further, a plate recess 90 is formed in the intermediate plate 72 by depression from the terminal joint surface 72b (on the side indicated by the arrow A1) toward the plate joint surface 72a (on the side indicated by the arrow A2, and the plate joint portion 86 is formed inside the plate recess 90.

For example, the terminal recess 92 is provided at substantially the center, etc., as viewed in the axial direction (indicated by the arrow A) of the intermediate plate 72, corresponding to the portion joined to the rod terminal 74. In the embodiment of the present invention as shown in FIG. 6B, the terminal recess 92 viewed in the axial direction has a circular shape having a diameter larger than that of the rod terminal 74. However, the present invention is not limited in this respect. For example, the shape of the terminal recess 92 as viewed in the axial direction may have a polygonal shape such as a quadrangular shape, or may have an annular shape.

FIGS. 3 and 4, the plate recess 90 is disposed on the outer circumferential side of the intermediate plate 72, corresponding to the position where the plate joint portion 86 (welding bead 88) is disposed. In the embodiment of the present invention, as shown in FIG. 3, the plate recess 90 as viewed in the axial direction has an annular shape along the outer circumference of the intermediate plate 72. However, the present invention is not limited in this respect. Various shapes and layout of the plate recess 90 may be adopted depending on the shapes and layout of the plate joint portion 86 (welding bead 88).

As shown in FIG. 1, the insulating plate 18 stacked on the outside of the terminal structure 16 in the stacking direction is made of insulating material such as polycarbonate (PC) or phenol resin, and has a quadrangular shape. Further, an accommodation recess 94 accommodating the intermediate plate 72 is provided on the side adjacent to the terminal structure 16 of the insulating plate 18 (inside in the stacking direction, the side of the first insulating plate 18a in the direction indicated by the arrow A2, and the side of the second insulating plate 18b indicated by the arrow A1).

A through hole 94a is formed at substantially the center of the accommodation recess 94 as viewed in the direction indicated by the arrow A. The rod terminal 74 is inserted into the through hole 94a through the insulating sleeve 80. An inner surface of the insulating plate 18 in the stacking direction contacts the other surface 70b of the current collection plate 70. Further, preferably, the inner surface of the insulating plate 18 in the stacking direction and the terminal joint surface 72b of the intermediate plate 72 are provided to face each other at a distance. Alternatively, the inner surface of the insulating plate 18 in the stacking direction and the terminal joint surface of the intermediate plate 72 may contact each other. On the other hand, the outer surface of the insulating plate 18 in the stacking direction contacts the end plate 20.

Operation of the fuel cell stack 10 having the above structure will be described briefly. In the case of performing power generation by the fuel cell stack 10 (FIG. 1), a fuel gas is supplied to the fuel gas supply passage 56a in FIG. 2, an oxygen-containing gas is supplied to the oxygen-containing gas supply passage 52a, and a coolant is supplied to the coolant supply passage 54a.

The fuel gas supplied to the fuel gas supply passage 56a flows into the fuel gas flow field 60 of the second separator 42, and flows along the anode 48. The oxygen-containing gas supplied to the oxygen-containing gas supply passage 52a flows into the oxygen-containing gas flow field 58 of the first separator 40, and flows along the cathode 46.

In the membrane electrode assembly 38, the fuel gas supplied to the anode 48 and the oxygen-containing gas supplied to the cathode 46 are partially consumed in electrochemical reactions in each of the electrode catalyst layers to perform power generation. The remaining fuel gas which has not been consumed in the electrochemical reactions is discharged from the fuel gas discharge passage 56b, and the remaining oxygen-containing gas is discharged from the oxygen-containing gas discharge passage is discharged from the oxygen-containing gas discharge passage 52b.

In the meanwhile, after the coolant supplied to the coolant supply passage 54a, the coolant flows through the coolant flow field 62 to cool the membrane electrode assembly 38, and then, the coolant is discharged from the coolant discharge passage 54b.

Hereinafter, a method of producing the terminal structure 16 (simply also referred to as the production method) according to the embodiment of the present invention will be described taking a case of producing the friction stir joining apparatus 76 shown in FIGS. 5 and 7. In the production method, preferably, the terminal structure 16 is obtained using the friction stir joining apparatus 76 which can perform friction stir joining. Alternatively, instead of the friction stir joining apparatus 76, the terminal structure 16 may be obtained using an apparatus (not shown) capable of performing laser welding, MIG welding, TIG welding. Further, since the first terminal structure 16a and the second terminal structure 16b have the same structure, hereinafter, only the method of producing the first terminal structure 16a will be described.

As shown in FIG. 5, for example, the friction stir joining apparatus 76 includes the rotation tool 96, the jig 78, and a fixing frame (not shown). The rotation tool 96 has a circular columnar shape, and the probe 98 is provided at a front end of the rotation tool 96.

At the time of welding the intermediate plate 72 and the rod terminal 74 together, the jig 78 serves as a backing gold of the rotation tool 96, and a fitting hole 100 having an inner circumferential shape corresponding to the outer circumferential shape of the rod terminal 74 is provided. That is, an hole side flat surface (not shown) is provided along the flat surface 74d of the rod terminal 74 on the inter circumference of the fitting hole 100.

As described above, the side where the flat surfaces 74d of the rod terminal 74 (side indicated by the arrow A1) are provided is inserted into the fitting hole 100. In this manner, the rod terminal 74 is attached to the jig 78. At this time, the end surface of the jig 78 in the direction indicated by the arrow Al contacts the step surface 74e of the rod terminal 74. As a result, the relative position between the rod terminal 74 and the jig 78 in the direction indicated by the arrow A is fixed. Further, since the flat surfaces 74d of the rod terminal 74 and the hole side flat surface of the fitting hole 100 face each other. The relative rotation between the rod terminal 74 and the jig 78 is limited.

As shown in FIG. 7, the fixing frames serves as a backing gold of the rotation tool 96, at the time of welding the intermediate plate 72 and the current collection plate 70, and the current collection plate 70 is fixed to the fixing frame.

In the method of producing the terminal structure 16 using the friction stir joining apparatus 76, firstly, as shown in FIG. 5, a terminal joining step of joining the intermediate plate 72 and the rod terminal 74 is performed. Specifically, in the terminal joining step, the rod terminal 74 is attached to the jig 78, and one end surface 74a on the side (indicated by the arrow A2) opposite to the jig 78 of the rod terminal 74 is brought into contact with the central side of the terminal joint surface 72b of the intermediate plate 72. In order to maintain the state where one end surface 74a of the rod terminal 74 and the terminal joint surface 72b of the intermediate plate 72 are brought into contact with each other, the intermediate plate 72, etc. may be supported by a support mechanism (not shown).

Then, the terminal joint portion 82 is formed inside the terminal recess 92 of the intermediate plate 72 by welding from the plate joint surface 72a. As shown in FIG. 6A, the terminal joint portion 82 joins the intermediate plate 72 and the rod terminal 74 on the central side of the intermediate plate 72 as viewed in the axial direction (viewed in the direction indicated by the arrow A). In the embodiment of the present invention, as shown in FIG. 5, while the rotation tool 96 of the friction stir joining apparatus 76 is rotated, friction stir joining is performed to embed the probe 98 at the front end of the rotation tool 96 in the intermediate plate 72 by pressing from the plate joint surface 72a to form the terminal joint portion 82.

As a result, as shown in FIG. 6A, the rod terminal 74 is welded to the terminal joint surface 72b of the intermediate plate 72 to obtain an intermediate joint body 102. In the intermediate joint body 102, the welding bead 84 is formed from the plate joint surface 72a of the intermediate plate 72 toward the rod terminal 74 (side in the direction indicated by the arrow A1). In the case where the portion protruding toward the outside of the terminal recess 92 (side in the direction indicated by the arrow A1) is produced in the welding bead 84, the protruding portion may be removed by machining, etc.

Next, as shown in FIG. 7, a plate joining step of joining the current collection plate 70 to the intermediate joint body 102 is performed. Specifically, in the plate joining step, the current collection plate 70 is placed on, and fixed to the fixing frame in a manner that one surface 70a of the current collection plate 70 is positioned adjacent to the fixing frame. Further, the plate joint surface 72a of the intermediate plate 72 is stacked at substantially the center of the other surface 70b of the current collection plate 70, to fix the relative positions of the current collection plate 70 and the intermediate plate 72.

Further, the plate joint portion 86 is provided inside the plate recess 90 of the intermediate plate 72 by welding from the terminal joint surface 72b. As shown in FIG. 4, the plate joint portion 86 joins the current collection plate 70 and the intermediate plate 72 on the outer circumferential side of the intermediate plate 72 as viewed in the axial direction (viewed in the direction indicated by the arrow A). In the embodiment of the present invention, as shown in FIG. 7, while the rotation tool 96 of the friction stir joining apparatus 76 is rotated, friction stir joining is performed to embed the probe 98 at the front end of the rotation tool 96 in the intermediate plate 72 by pressing from the terminal joint surface 72b, and moving the probe 98 to draw a circular trajectory, to form the plate joint portion 86.

As a result, as shown in FIG. 4, the rod terminal 74 is welded to the terminal joint surface 72b of the intermediate plate 72, and the current collection plate 70 is welded to the plate joint surface 72a of the intermediate plate 72 to form the terminal structure 16. In the terminal structure 16, the welding bead 88 is formed from the terminal joint surface 72b of the intermediate plate 72 toward the current collection plate 70 (the side indicated by the arrow A2). Further, one surface 70a of the current collection plate 70 is flat at least in the plate joint portion 86 and a region adjacent to the plate joint portion 86. In the case where part of the welding bead 88 protrudes outside of the plate recess 90 (toward the side indicated by the arrow A2), the protruding portion may be removed by machining, etc.

As described above, in the terminal structure 16, the rod terminal 74 is joined to the terminal joint surface 72b of the intermediate plate 72, and the current collection plate 70 is joined to the plate joint surface 72a of the intermediate plate 72. In this case, the terminal joint portion 82 which joins the intermediate plate 72 and the rod terminal 74 together may be positioned adjacent to the surface (other surface 70b) of the current collection plate 70 opposite to the stack body 14. Further, the plate joint portion 86 which joins the intermediate plate 72 and the current collection plate 70 together can be formed by joining from the terminal joint surface 72b of the intermediate plate 72. In this manner, it is possible to easily flatten one surface 70a of the current collection plate 70, of at least the plate joint portion 86.

That is, by joining the current collection plate 70 and the rod terminal 74 together through the intermediate plate 72, it is possible to avoid formation of the welding bead (not shown) from the surface (one surface 70a) of the current collection plate 70 adjacent to the stack body 14. Therefore, it is possible to avoid formation of projections such as burrs provided as a result of welding in the one surface 70a of the current collection plate 70. As a result, it is possible to stack the one surface 70a of the flat current collection plate 70 on the stack body 14 without providing recesses, etc. for avoiding contact between the projections and the stack body 14.

As a result, in the terminal structure 16, it is possible to suitably ensure that the contact area between the stack body 14 and the current collection plate 70 is sufficient. Moreover, for example, it becomes possible to apply the tightening load from the end plate 20 to the entire stack body 14 through the terminal structure 16, and efficiently collect the power generation electrical energy of the stack body 14 to the outside by the terminal structure 16.

In the fuel cell stack 10 according to the embodiment of the present invention, each of the terminal joint portion 82 and the plate joint portion 86 is formed by friction stir joining.

Further, in the terminal joining step of the production method according to the embodiment, friction stir joining is performed to embed the probe 98 provided at the front end of the rotating rotation tool 96 in the intermediate plate 72 by pressing from the plate joint surface 72a, to form the terminal joint portion 82, and in the plate joining step, friction stir joining is performed to embed the probe 98 in the intermediate plate 72 by pressing from the terminal joint surface 72b, to form the plate joint portion 86.

In this case, in comparison with the other welding methods such as melt welding (fusion welding), it is possible to suppress heat deformation, etc. of the current collection plate 70 and/or the intermediate plate 72. Therefore, it becomes easy to suitably bring the constituent components of the terminal structure 16 into contact with each other, and the current collection plate 70 and the stack body 14 into contact with each other, and thereby suppress increase in the contact resistance. As a result, it is possible to increase the current collection performance by the terminal structure 16.

Further, since the plate joint portion 86 is formed by friction stir joining, in the intermediate plate 72 and the current collection plate 70 that are stacked together, also in the case of forming the welding bead 88 from the terminal joint surface 72b of the intermediate plate 72 up to the one surface 70a of the current collection plate 70, it is possible to easily flatten the one surface 70a of the current collection plate 70 in the plate joint portion 86. Therefore, it is possible to firmly join the intermediate plate 72 and the current collection plate 70 together, and ensure that the contact area between the current collection plate 70 and the stack body 14 is sufficient.

In the fuel cell stack 10 according to the embodiment of the present invention, the terminal recess 92 is formed in the intermediate plate 72 by depression from the plate joint surface 72a toward the terminal joint surface 72b, and the terminal joint portion 82 is formed inside the terminal recess 92.

Further, in the production method according to the embodiment of the present invention, the terminal recess 92 is formed in the intermediate plate 72 by depression from the plate joint surface 72a toward the terminal joint surface 72b, and the terminal joint portion 82 is formed inside the terminal recess 92.

In this case, by forming the welding bead 84 in the terminal joint portion 82 from the side adjacent to the plate joint surface 72a, even if projections such as burrs are produced in the plate joint surface 72a, it is possible to easily eliminate and/or suppress the situations where the projections protrude from the plate joint surface 72a toward the current collection plate 70 (indicated by the arrow A2).

In this manner, for example, it is possible to suitably bring the intermediate plate 72 and the current collection plate 70 into contact with each other, and it is possible to reduce the contact resistance between the intermediate plate 72 and the current collection plate 70. Moreover, it becomes possible to increase the current collection performance by the terminal structure 16. It should be noted that terminal recess 92 may be provided for the intermediate plate 72 after forming the terminal joint portion 82.

In the fuel cell stack 10 according to the embodiment of the present invention, the plate recess 90 is formed in the intermediate plate 72 by depression from the terminal joint surface 72b toward the plate joint surface 72a, and the plate joint portion 86 is formed inside the plate recess 90.

Further, the plate recess 90 is provided in the intermediate plate 72 by depression from the terminal joint surface 72b toward the plate joint surface 72a, and in the plate joining step of the production method according to the embodiment of the present invention, the plate joint portion 86 is formed inside the plate recess 90.

In this case, by forming the welding bead 88 in the plate joint portion 86 from the side adjacent to the terminal joint surface 72b, even if the projections such as burrs are produced in the terminal joint surface 72b, it is possible to eliminate and/or suppress the situations where the projections protrude from the terminal joint surface 72b toward the insulating plate 18 (toward the side indicated by the arrow A1). Accordingly, when the insulating plate 18, etc. is stacked on the terminal joint surface 72b of the intermediate plate 72, it is possible to suppress rattling, etc., between the terminal joint surface 72b and the insulating plate 18. Moreover, it becomes possible to suitably apply the tightening load from the end plate 20 to the stack body 14.

It should be noted that the plate recess 90 may be provided in the intermediate plate 72 after forming the plate joint portion 86. Further, the plate recess 90 may not be provided in the intermediate plate 72. The plate joint portion 86 may be provided in the flat terminal joint surface 72b.

The present invention is not limited to the above described embodiment of the present invention. Various modifications can be made without departing from the gist of the present invention.

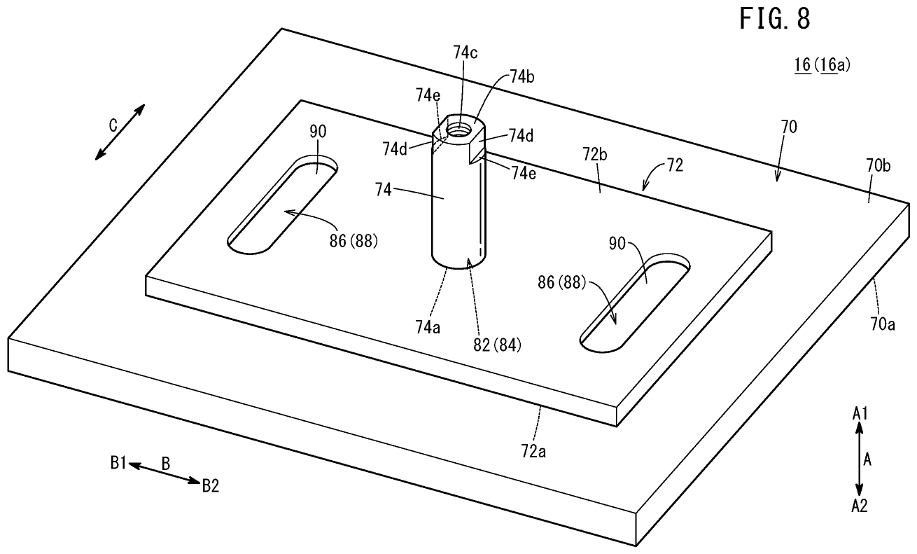

In the terminal structure 16 according to the above embodiment, as shown in FIG. 3, as viewed in the direction indicated by the arrow A, the intermediate plate 72 has a circular shape, and the welding bead 88 (plate joint portion 86) and the plate recess 90 are formed in an annular shape around the outer circumferential portion of the intermediate plate 72. However, instead of adopting these features, for example, as in the case of the terminal structure 16 shown in FIG. 8, the shape of the intermediate plate 72 in the direction indicated by the arrow A may be a quadrangular shape (rectangular shape) other than the outer shape of the current collection plate 70.

Further, as shown in FIG. 8, as viewed in the direction indicated by the arrow A, the plate recess 90 may have a rectangular shape having rounded corners (oval shape) where both ends of the intermediate plate 72 in a long side direction (indicated by the arrow B) extend along the short side direction (indicated by the arrow C). As viewed in the direction indicated by the arrow A, the welding bead 88 (plate joint portion 86) may be provided in the plate recess 90 in FIG. 8 in an oval shape, or an annular shape. Alternatively, the welding bead 88 may be provided in a wavy serpentine pattern, or in a dot pattern.

What is claimed is:

1. A fuel cell stack comprising:
a stack body including a plurality of power generation cells stacked together in a stacking direction; and
terminal structures provided at both ends of the stack body in the stacking direction,
wherein each of the terminal structures comprises:
an electrically conductive current collection plate having one surface and another surface, the one surface of the current collection plate being positioned adjacent to the stack body;
an electrically conductive intermediate plate including a plate joint surface and a terminal joint surface as a back surface of the plate joint surface, the plate joint surface being joined to the other surface of the current collection plate; and
an electrically conductive rod terminal joined to the terminal joint surface of the intermediate plate, and protruding from the intermediate plate toward a side opposite to the stack body;
wherein a terminal joint portion configured to join the intermediate plate and the rod terminal together is provided at a central side of the intermediate plate as viewed in the stacking direction; and
a plate joint portion configured to join the current collection plate and the intermediate plate together is provided on an outer circumferential side of the intermediate plate as viewed in the stacking direction.

2. The fuel cell stack according to claim 1, wherein a terminal recess is formed in the intermediate plate by depression from the plate joint surface toward the terminal joint surface, and the terminal joint portion is formed inside the terminal recess.

3. The fuel cell stack according to claim 1, wherein a plate recess is formed in the intermediate plate by depression from the terminal joint surface toward the plate joint surface, and the plate joint portion is formed inside the plate recess.

4. A terminal structure for a fuel cell stack, the fuel cell stack comprising a stack body including a plurality of power generation cells stacked together in a stacking direction, the terminal structures provided at both ends of the stack body in the stacking direction,
wherein each of the terminal structures comprises:
an electrically conductive current collection plate having one surface and another surface, the one surface of the current collection plate being positioned adjacent to the stack body;
an electrically conductive intermediate plate including a plate joint surface and a terminal joint surface as a back surface of the plate joint surface, the plate joint surface being joined to the other surface of the current collection plate; and
an electrically conductive rod terminal joined to the terminal joint surface of the intermediate plate, and protruding from the intermediate plate toward a side opposite to the stack body;
wherein a terminal joint portion configured to join the intermediate plate and the rod terminal together is provided at a central side of the intermediate plate as viewed in the stacking direction; and
a plate joint portion configured to join the current collection plate and the intermediate plate together is provided on an outer circumferential side of the intermediate plate as viewed in the stacking direction.

5. A method of producing a terminal structure for a fuel cell stack, the fuel cell stack comprising: a stack body including a plurality of power generation cells stacked together in a stacking direction; and the terminal structures provided at both ends of the stack body in the stacking direction,
wherein each of the terminal structures comprises:
an electrically conductive current collection plate having one surface and another surface,
an electrically conductive intermediate plate including a plate joint surface and a terminal joint surface as a back surface of the plate joint surface; and
an electrically conductive rod terminal,
the method comprising the steps of:
in a state where one end surface of the rod terminal in an axial direction is brought into contact with a central side of the terminal joint surface of the intermediate plate, joining the intermediate plate and the rod terminal together at a central side of the intermediate plate as viewed in the axial direction by welding from the plate joint surface, to provide a terminal joint portion; and
in a state where the plate joint surface of the intermediate plate after the terminal joining step is brought into contact with the other surface of the current collecting plate before the one surface of the current collection plate is positioned adjacent to the stack body, joining the current collection plate and the intermediate plate together on an outer circumferential side of the intermediate plate as viewed in the axial direction by welding from the terminal joint surface, to provide a plate joint portion.

6. The method of producing the terminal structure of the fuel cell stack according to claim 5, wherein
in the terminal joining step, friction stir joining to embed a probe provided at a front end of a rotating rotation tool in the intermediate plate by pressing from the plate joint surface is performed, to form the terminal joint portion; and
in the plate joining step, friction stir joining is performed to embed the probe in the intermediate plate by pressing from the terminal joint surface, to form the plate joint portion.

7. The method of producing the terminal structure for the fuel cell stack according to claim 5, a terminal recess is formed in the intermediate plate by depression from the plate joint surface toward the terminal joint surface, and in the terminal joining step, the terminal joint portion is formed inside the terminal recess.

8. The method of producing the terminal structure for the fuel cell stack according to claim 5, wherein a plate recess is formed in the intermediate plate by depression from the terminal joint surface toward the plate joint surface, and in the plate joining step, the plate joint portion is formed inside the plate recess.
